(19) United States
(12) Patent Application Publication
(10) Pub. No.: US 2010/0270252 A1
(43) Pub. Date: Oct. 28, 2010

(54) Ceiling Lift and Ceiling Lift Components

(75) Inventors: Mark P. Chepurny, Bradford (CA); Mikel Shani, Mississauga (CA)

Correspondence Address: THE WEBB LAW FIRM, P.C., 700 KOPPERS BUILDING, 436 SEVENTH AVENUE, PITTSBURGH, PA, 15219, US

(73) Assignee: PRISM MEDICAL LTD., Vaughan (CA)

(21) Appl. No.: 12/295,007

(22) PCT Filed: Mar. 28, 2007
(86) PCT No.: PCT/IB07/02890

§ 371 Date: Jul. 7, 2010

Related U.S. Application Data
(60) Provisional application No. 60/787,389, filed on Mar. 30, 2006.

(51) Int. Cl. B66C 17/00; B66D 1/02; B23P 11/00; F16G 11/00; G04F 10/00

(52) U.S. Cl. 212/76; 254/264; 29/428; 403/52; 702/176

(57) ABSTRACT

The present application relates to ceiling lifts and ceiling lift components. One embodiment relates to a ceiling lift gear box that is made from multiple plates. One embodiment relates to a swivel assembly. One embodiment relates to a ceiling lift display. One embodiment relates to use of an optocoupler in a ceiling lift.

This application claims the benefit of U.S. Provisional Patent Application Ser. No. 60/787,389, filed Mar. 30, 2006, the entire disclosure of which is hereby incorporated by reference.

### BACKGROUND OF THE INVENTION

Personal lift or patient lift devices have been known and used in the past for the purpose of assisting with the mobility of otherwise immobilized patients. An attendant may help physically disabled patients who may have suffered a traumatic injury, stroke or one form of illness or another, and who are unable to move about. However, often such patients may be too heavy to lift or the attendant may not have enough strength to help the patient move. This can be especially true for disabled patients who have reduced mobility but have otherwise normal bodily functions. Getting up, going to the bathroom and taking a bath, for example, can be difficult for such patients.

Personal lift devices that have been used in the past typically include a strap or chain hanging down from a motor assembly, which in turn may be suspended from a carriage or trolley that rides along an overhead track. An overhead track can be organized to extend from over a bed and into, for example, an adjoining bathroom area, to permit the patient to be raised, suspended, and then moved along the track to a position where the patient can be lowered into the bathtub for the purposes of a bath, or onto a toilet.

The track may be affixed to the ceiling, or extend between two posts. The trolley includes wheels that allow the trolley to roll along the track. Also, included in the trolley are a lift motor, gears coupled to the lift motor, and a lifting strap. Other common components are limit switches to shut the motor off when the strap reaches its upper and lower limits, and emergency lowering devices for lowering the patient safely in the event that the device malfunctions. Typically, a control panel for use by the care-giver is attached by a wire to the trolley. The control panel may be either pneumatic or electrical. The control panel typically includes buttons that activate the motor to lift or lower the patient, and to move right or left along the track.

### SUMMARY

The present application relates to ceiling lifts. In one exemplary embodiment, a ceiling lift gear box assembly is made from separate plates. For example, such a ceiling lift gear box may include a top plate, first and second side plates, and a bottom plate. The side plates are assembled with the top and bottom plates to define an interior space of the gear box. A drive gear and a driven gear are disposed in the interior space. Rotation of the drive gear causes rotation of the driven gear to raise or lower a carry bar.

In one exemplary embodiment, components of a ceiling lift gear box are assembled to separate plates to form lift gear box subassemblies. The separate plates are assembled together to construct the ceiling lift box. In one embodiment, the plates are assembled together by slideably engaging the plates with one another.

In one exemplary embodiment, a ceiling lift assembly is serviced by slideably disengaging a plate assembly with mounted components of the lift to disassemble the plate assembly from a remainder of a gear box assembly to access components of the ceiling lift assembly. Components of the lift assembly are then accessible for service. assembly to reassemble the plate assembly to the remainder of the gear box assembly.

In one exemplary embodiment, a swivel connection that permits relative rotation between a line and an attached member, such as a carry bar. The swivel connection may include an outer swivel member, an inner swivel member, and a stop member. The outer swivel member is connected to the attached member, such as the carry bar. The inner swivel member is axially constrained in a recess of the outer swivel member. The inner swivel member defines a cavity and a lift line opening. The stop member is disposed in the cavity with a loop of the line disposed around the stop member. The stop member engages the end wall of the inner swivel member to prevent the loop from being pulled through the line opening. The inner swivel member is rotatable with respect to the outer swivel member to facilitate rotation of the member, such as the carry bar, attached to the line.

In one embodiment, a lift line and a carry bar are connected to permit relative rotation between the lift line and the carry bar comprising. For example, a loop of the lift line may be inserted through a swivel member and the carry bar. A stop member is inserted into the loop. The lift line is pulled to pull the loop and stop member through the carry bar and into engagement with the swivel member. The swivel member allows relative rotation between the lift line and the carry bar.

In one embodiment, a ceiling lift includes a display. For example, the ceiling lift may include a lifting mechanism, a controller in communication with the lifting mechanism, a user control in communication with the controller, a lift line, and a display. The lift line is selectively extended and retracted by the lifting mechanism unit upon operation of the user control. The controller is programmed to monitor the extending and retracting of the lift line. The display is in communication with the controller and displays information relating to extending and retracting of the lift line.

In one embodiment, a number of lifts performed by a ceiling lift is determined. For example, actuation of a ceiling lift control may be sensed. An amount of time the ceiling lift control is actuated may be tracked. The number of lifts may be calculated based on the amount of time the control is actuated.

In one embodiment, a control board of a ceiling lift includes an optocoupler. For example, an optocoupler may be in communication with a controller and a user control of the lift for protecting the controller from electromagnetic noise.

Further advantages and benefits will become apparent to those skilled in the art after considering the following description and appended claims in conjunction with the accompanying drawings.

### BRIEF DESCRIPTION OF THE DRAWINGS

FIG. 1 is an elevational view of a ceiling lift;

FIG. 2 is a sectional view taken as indicated by lines 2-2 in FIG. 1;

FIG. 3 is a schematic illustration of a ceiling lift gear box in accordance with one embodiment of the present invention;

FIG. 4 is a view taken along lines 4-4 in FIG. 3;

FIG. 5 is a perspective view of a ceiling lift gear box in accordance with one embodiment of the present invention;

FIG. 5A is an exploded perspective view showing the lift gear box of FIG. 5, a lift control board, and lift batteries;

FIG. 6 is an exploded perspective view of a top plate assembly of the ceiling lift gear box of FIG. 5;

FIG. 7 is an exploded perspective view of a side plate assembly of the ceiling lift gear box of FIG. 5;

FIG. 8 is an exploded perspective view of a side plate assembly of the ceiling lift gear box of FIG. 6;

FIG. 9 is an exploded perspective view of a bottom plate assembly of the ceiling lift gear box of FIG. 6;

FIG. 10 is a perspective view of a carry bar supported by a prior art swivel;

FIGS. 11A-11C are illustrations of an inner swivel member;

FIGS. 12A-12C are illustrations of an outer swivel member attached to a supported member with the inner swivel member disposed in the outer member;

FIGS. 13A-13C are illustrations of an outer swivel member attached to a supported member with the inner swivel member axially constrained in the outer member;

FIGS. 14A and 14B illustrate attachment of a line to the swivel assembly;

FIGS. 15A and 15B illustrate the line attached to the swivel assembly;

FIG. 16 is a perspective view of a carry bar with an attached outer swivel member;

FIG. 17 is an exploded perspective view of a carry bar and a swivel assembly;

FIG. 18 is an exploded perspective view of a carry bar and a swivel assembly;

FIG. 19 is a perspective view of a strap being attached to a carry bar with a swivel assembly;

FIG. 20 is a schematic illustration of a prior art style swivel;

FIG. 21 is a perspective view of a ceiling lift with a display;

FIG. 22 is a schematic illustration of a ceiling lift with a display;

FIG. 23 is a flow chart that illustrates a method of counting a number of lifts performed by a ceiling lift; and

FIG. 24 is a schematic illustration of a ceiling lift with an optocoupler.

### DETAILED DESCRIPTION

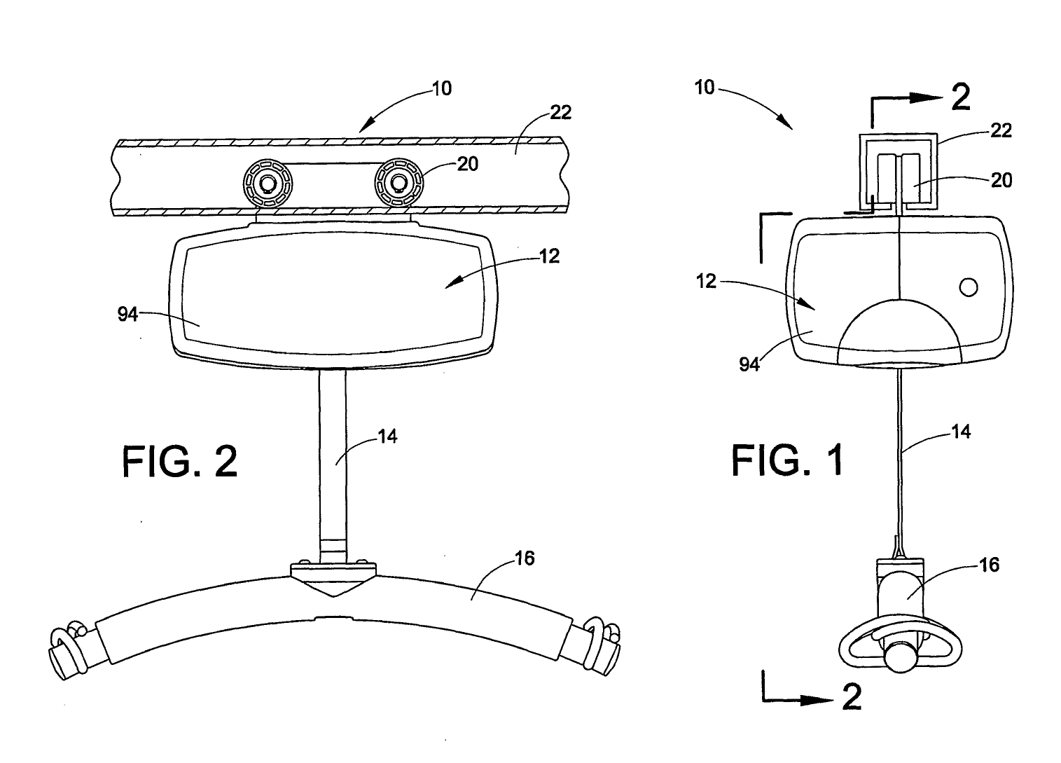

The present application relates to ceiling lifts 10 and components of ceiling lifts. FIGS. 1 and 2 illustrate one exemplary ceiling lift 10. The ceiling lift 10 includes a lift unit 12, a lift line 14, and a carry bar 16. The lift unit 12 is operated to selectively extend and retract the lift line 14. The carry bar may be attached to a patient sling 18 (see FIG. 10). The line 14 selectively lifts and lowers a patient in the sling 18. The lift unit 12 includes rollers 20 that ride in an elevated track 22. When the patient is lifted, the patient can be moved by rolling the lift unit 12 along the track.

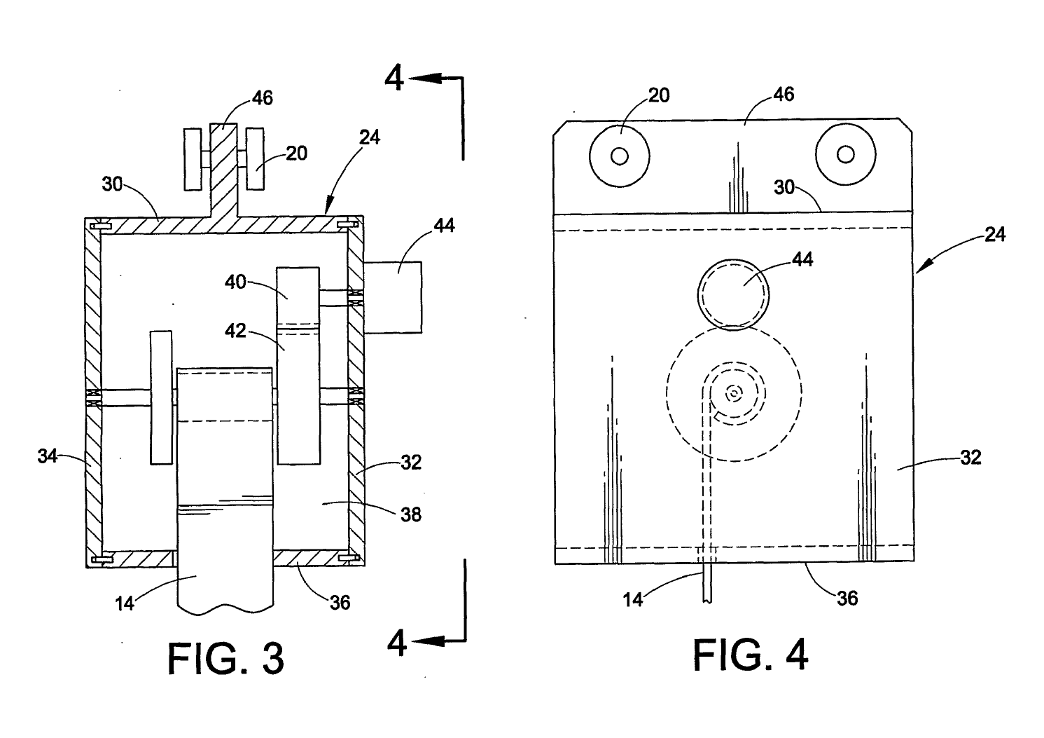

Referring to FIGS. 3 and 4, the lift unit 12 includes a gear box 24 or drive train support box. In one exemplary embodiment, the gear box 24 is made from separate plates. For example, such a ceiling lift gear box may include a top plate 30, first and second side plates 32, 34, and a bottom plate 36. The side plates 32, 34 are assembled with the top and bottom plates 30, 36 to define an interior space 38 of the gear box.

Referring to FIGS. 3 and 4, a drive gear 40 and a driven gear 42 are disposed in the interior space 38. The drive gear 40 and the driven gear 42 define a drive train. A wide variety of different drive trains can be used. For example, the drive disclosed by US Patent Application Publication No. 2005/0115914 can be used. US Patent Application Publication No. 2005/0115914 is incorporated herein by reference in its entirety. A drive motor 44 is coupled to an outer surface of the gear box 24. The motor 44, the gears 40, 42 and the gear box 24 define a gear box assembly. The motor 44 drives the gear 40. Rotation of the drive gear 402 causes rotation of the driven gear 42 to raise or lower the lift line 14 and the attached carry bar 16 (See FIG. 1). Rotation of the driven gear 42 in a first direction extends the line from the interior space 38. Rotation of the driven gear 42 in a second direction retracts the line into the interior space 38. The lift line 14 may take a wide variety of different forms. For example, the lift line may be a strap, a cable, a chain, or a rope.

In the example illustrated by FIGS. 3 and 4, a flange 46 extends from the top plate. Rollers 20 are rotatably mounted to the top plate flange 46. The rollers 20 are configured to ride in the ceiling mounted track (See FIGS. 1 and 2). In this embodiment, the rollers 20 are integrated with the gear box 24 and a separate roller assembly and an arrangement, such as a mounting plate, for mounting the roller assembly to the gear box is not required.

The top, bottom and side plates may be assembled in a wide variety of different manners. Any connection arrangement that allows the plates to be connected and disconnected may be employed. For example, conventional fasteners may be used, snap-together type connections may be used, or slide-together connections, such as a tongue and groove connection may be used.

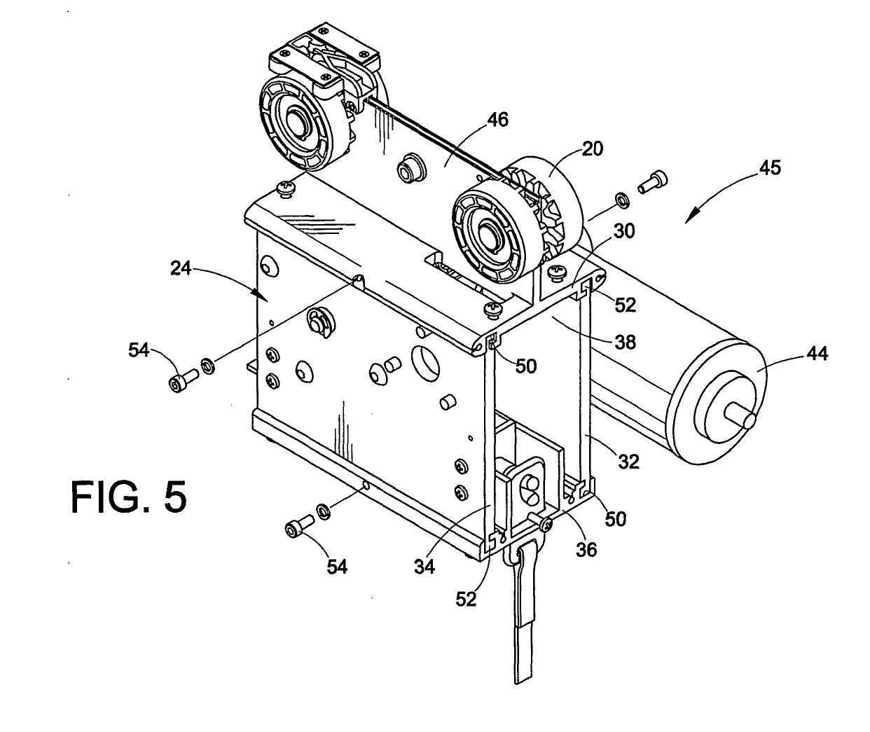

FIG. 5 illustrates an exemplary gear box 24 with top 30, bottom 36 and side plates 32, 34 connected by a tongue and groove connection. In the example, the top and bottom plates 30, 36 include grooves 50 or slots and the side plates 32, 34 include tongues 52 or protrusions. It should be readily apparent that the tongues and grooves could be provided on the plates in any manner that allows the plates to be assembled to form a gear box. To assemble the gear box 24, the tongues 52 and grooves 50 are slid together to connect the plates. One or more fasteners 54 may be used to secure the relative positions of the plates.

The top plate 30, the first side plate 32, the second side plate 34, and the bottom plate 36 may be formed in a wide variety of different ways from a wide variety of different materials. For example, one or more of the plates may be formed by extruding aluminum.

Referring to FIGS. 5A and 6-9, a gear box 24 made from multiple pieces also allows several people to build the ceiling lift parallel. Each plate can be given to a different person, who will attach the necessary components. The plates can then be assembled in sliding engagement to form the gear box assembly. The assembly of the gear box made from multiple plates is much easier and less time consuming than assembly of prior gear box assemblies. As a result, the gear box made from multiple plates substantially reduces the cost of the gear box assembly. FIG. 5A illustrates that batteries 60, a control board 62 and other components can be attached to the gearbox 24 after the gearbox assembly 45 has been formed. In the example illustrated by FIG. 5A, the control board 62 includes the electronics that receive inputs from a user control 64 (see FIG. 24) and control operation of the motor 44 is attached to the outside of the multi-piece frame.

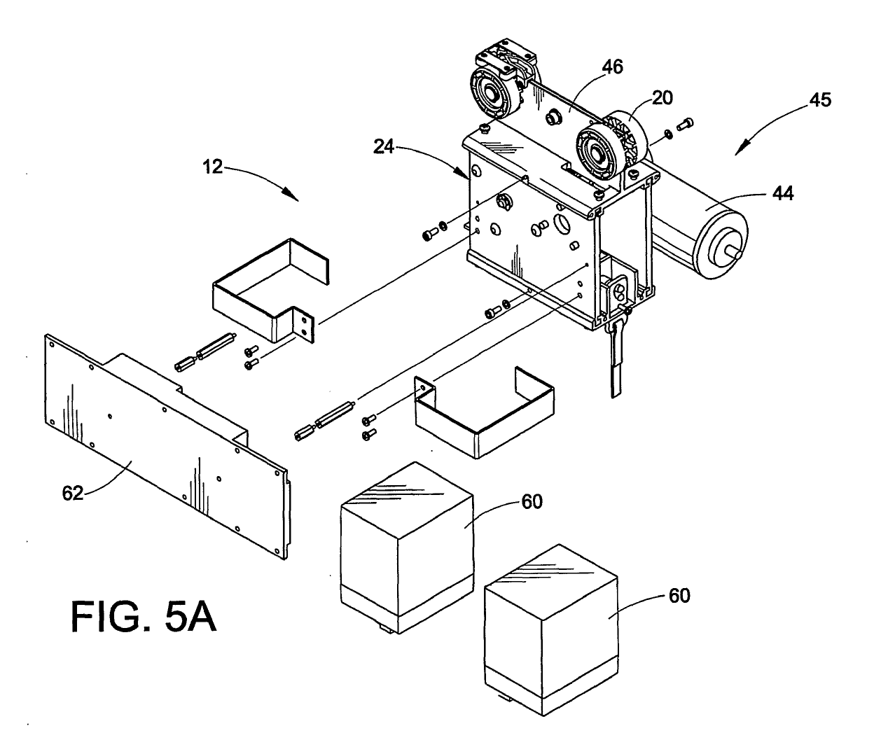

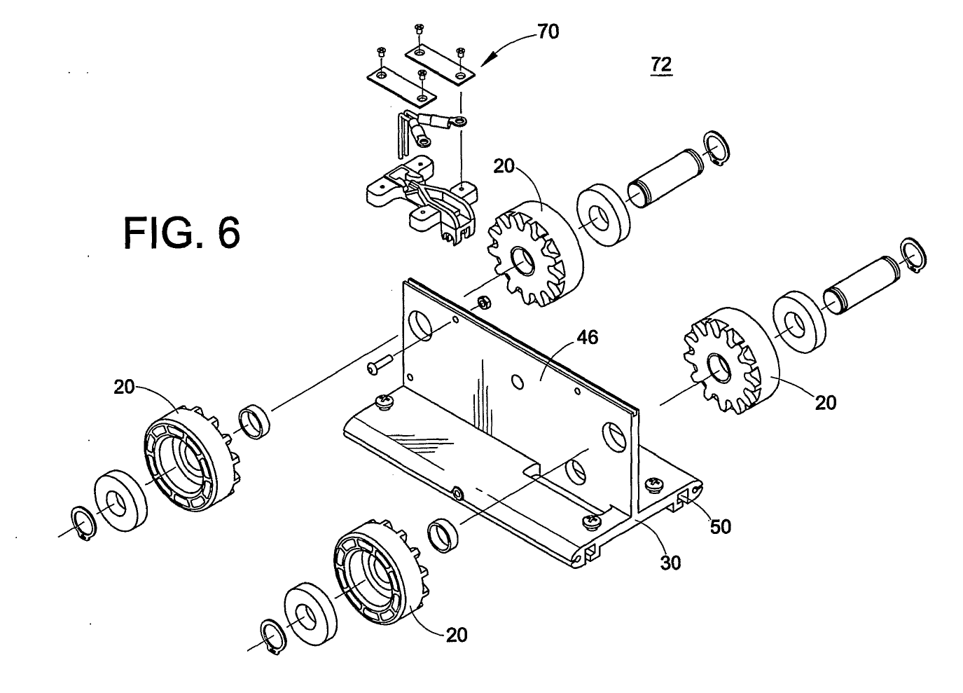

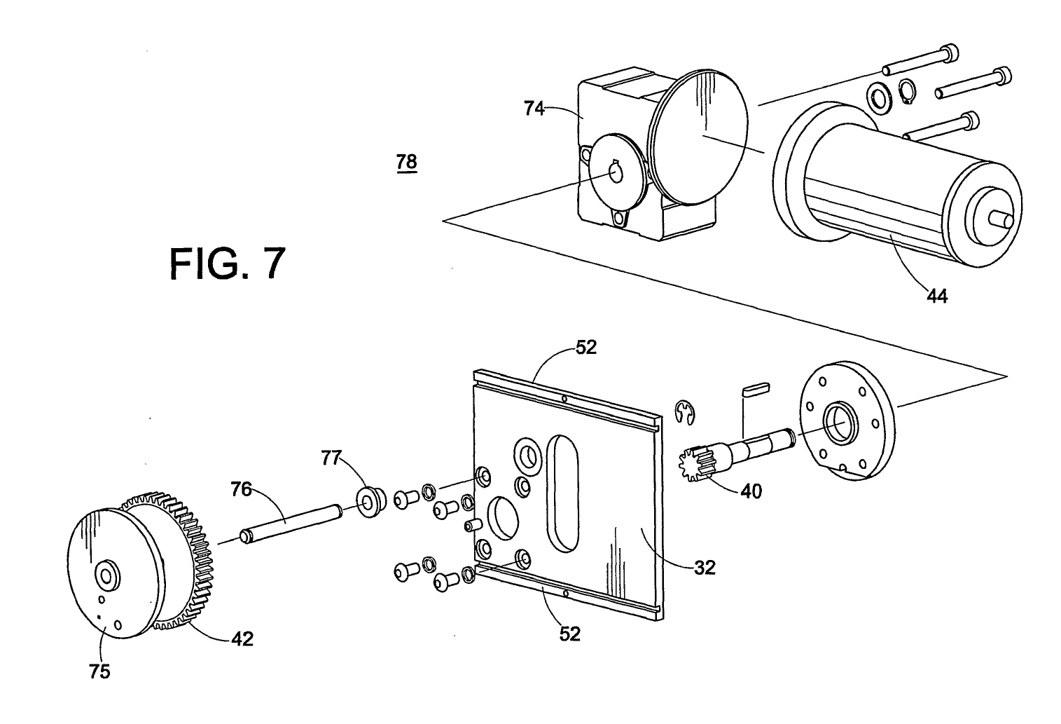

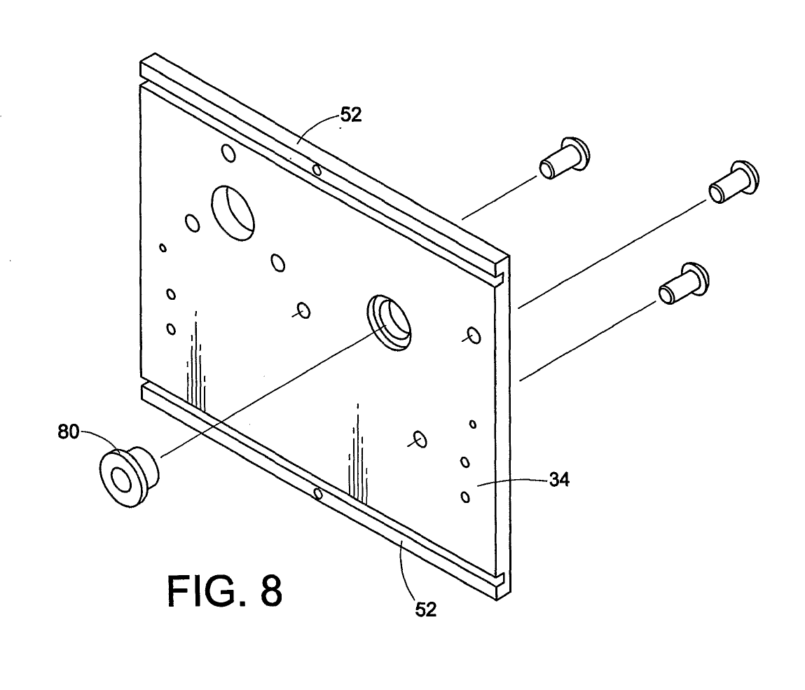

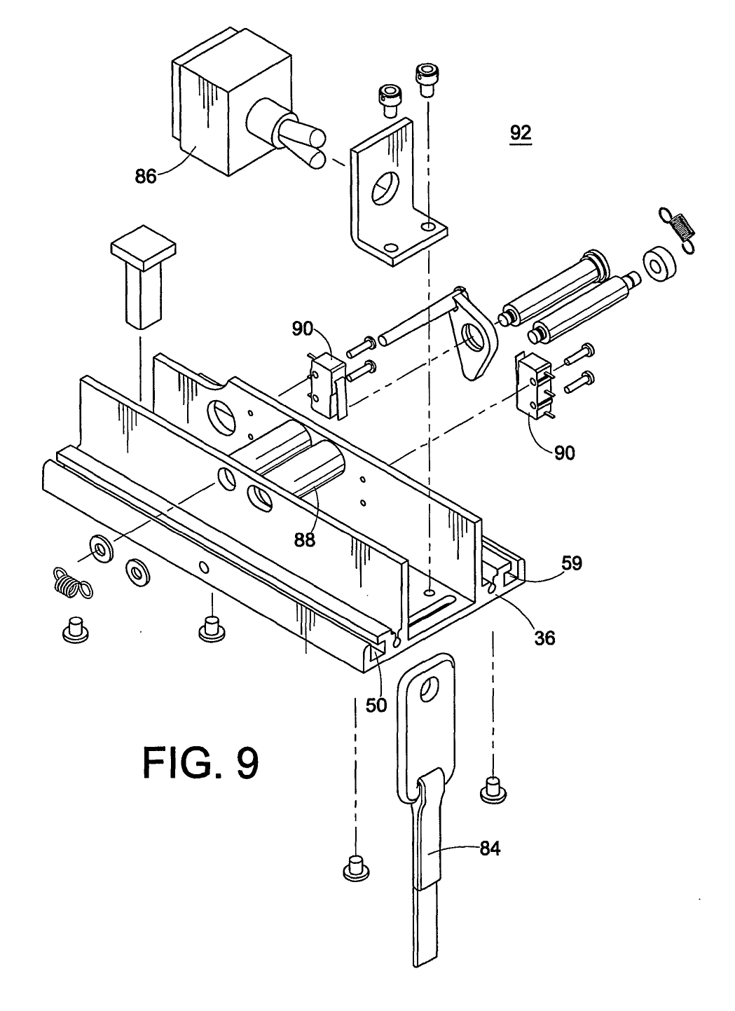

FIGS. 5-9 illustrate one exemplary embodiment where components of the lift gear box assembly 45 are assembled to separate plates to form lift gear box subassemblies. The separate plates are assembled together to construct the ceiling lift box. Referring to FIG. 6, rollers 20, and a charging arrangement 70 are assembled with the top plate 30 to form a top plate assembly 72. Referring to FIG. 7, the motor 44, a gear box 74 or transmission, the drive gear 40, the driven gear 42, a strap plate 75, a strap pin 76 and a first strap pin bushing 77 are assembled with the first side plate 32 to form a first side plate assembly 78. Referring to FIG. 8, a strap pin bushing 80 is assembled with the second side plate 34 to form a second side plate assembly 82. It should be readily apparent that sub assemblies need not be formed on all of the plates. Referring to FIG. 9, an emergency stop strap 84, a power switch 86, strap rollers 88, and limit switches 90 are assembled with the lower plate 36 to form a lower plate assembly 92. The stop strap 84 stops the motor 44 when pulled by turning the power switch 86 off. The limit switches 90 are arranged to sense when the lift line 14 reaches an upper limit and when there is slack in the lift line.

Referring to FIGS. 5 and 5A, the first side plate 32 and the second side plate 34 slideably engage the top plate 30 to assemble the first side plate assembly 78 (See FIG. 7) and the second side plate assembly 82 (See FIG. 8) with the top plate assembly 72 (See FIG. 6). The first side plate 32 and the second side plate 34 slideably engage the bottom plate 36 to assemble the first side plate assembly 78 and the second side plate assembly 82 with the top plate assembly 92 (See FIG. 9) and form the gear box assembly 45. Referring to FIG. 5A, the batteries 60 and control board 62 are assembled to the gear box assembly. Referring to FIGS. 1 and 2, a shroud 94 is placed over the gear box assembly 45.

Assembling the gear box 24 from multiple plates has several advantages over a gear box made from single piece of material, such as an extruded or cast single piece gear box. For example, persons building the ceiling lift have access to both sides of each plate as they are attaching the various components. It is not necessary to leave unused a substantial amount of interior space for the purpose of ensuring that a screwdriver or other tool can be used to reach through the interior space. Rather, all of the necessary components can be attached to each plate, and the plates are then put together in sliding engagement to form the gearbox. The result is that the interior space may be much more densely populated than is possible if the box is made from a single piece of material. In addition, all of the components of the lift unit can be mounted directly to the gear box. In prior ceiling lift assemblies, the gear box and other components such as the motor and a transmission for transferring power from the motor to the drive gear were mounted to a secondary support structure or a frame, such as a plate. Since the frame made from separate plates can be more densely populated and a secondary support structure is not required, the volume of the disclosed lift unit is less than existing lift units. For example, typical lift units rated at 425 pounds of lift capacity have a volume range of approximately 800 to 1200 cubic inches (i.e. a volume to lift capacity ratio range of about 1.8 to 2.9 cubic inches per pound of lift capacity). In one exemplary embodiment, a lift having a frame made from separate plates having a lift capacity of 625 pounds has a volume of approximately 500 cubic inches (i.e. a volume to lift capacity ratio of about 0.8 cubic inches per pound of lift capacity).

The reduced volume and elimination of a structure, such as a plate, for mounting the roller assembly to the gear box reduces the weight of the gear box assembly 45. As such, the disclosed gear box assembly 45 has a lower weight to lifting-capacity ratio in the exemplary embodiment.

The configuration of the gear box 24 makes maintenance easier as it is possible to quickly reach the target component by sliding the plates apart, without having to disconnect all of the main components. In one exemplary embodiment, the ceiling lift assembly 45 is serviced by slideably disengaging one of the plate assemblies with mounted components to disassemble the plate assembly from a remainder of a gear box assembly to access components of the ceiling lift assembly. Components of the lift assembly are then accessible for service.

FIGS. 10 and 20 illustrate a “U” shaped swivel assembly 100. The “U” shaped swivel permits rotation of an attached member with respect to a line. The “U” shaped swivel includes a “U” shaped member 102 rotatably connected to a shaft 104. The “U” shaped swivel 100 extends a considerable distance in the direction labeled “D.”

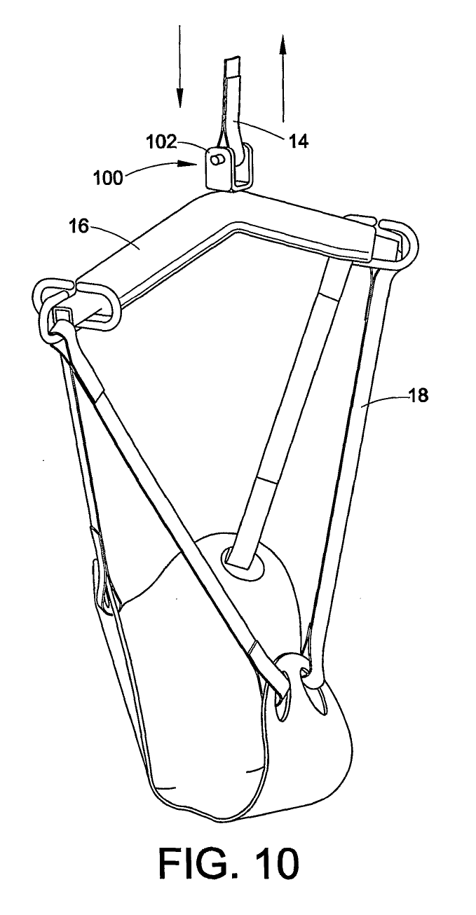

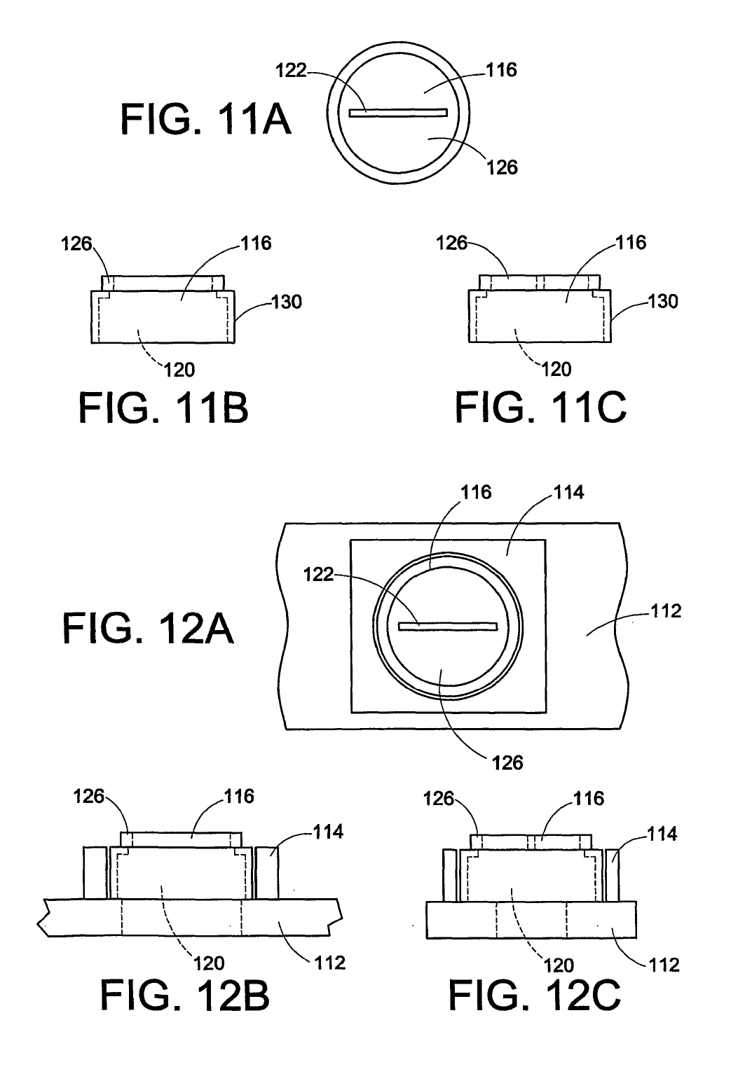

FIGS. 11A-11C, 12A-12C, 13A-13C, 14A, 14B, 15A and 15B illustrate an example of a swivel assembly 110 that permits relative rotation between the line 14 and an attached member 112. The swivel assembly 110 includes an outer swivel member 114, an inner swivel member 116, and a stop member 118. The outer swivel member 114 is connected to the attached member 112. The inner swivel member 116 is axially constrained in a recess 119 of the outer swivel member 114. The inner swivel member 116 defines a cavity 120 and a line opening 122. The stop member 118 is disposed in the cavity 120 with a loop 124 of the line disposed around the stop member. The stop member 118 engages an end wall 126 of the inner swivel member 116 to prevent the loop 124 from being pulled through the line opening 122. The inner swivel member 116 is rotatable with respect to the outer swivel 114 member to facilitate rotation of the attached member 112 with respect to the line 14. The swivel assembly can be used in any application where rotation of a member with respect to a line is desired, including, but not limited to, personal lift applications.

Referring to FIGS. 12A-12C, the recess 119 of the illustrated outer swivel member 114 is circular. Referring to FIGS. 11A-11C, the illustrated inner swivel member 116 includes a disk shaped end wall 126 and an annular side wall 130 that extends axially from the end wall to define the cavity 120. The recess 119 and the inner swivel member 116 can comprise any shapes that allow the inner swivel member to rotate in the recess. The line opening 122 through the end wall is illustrated as a rectangular opening for applications where the line 14 is a strap.

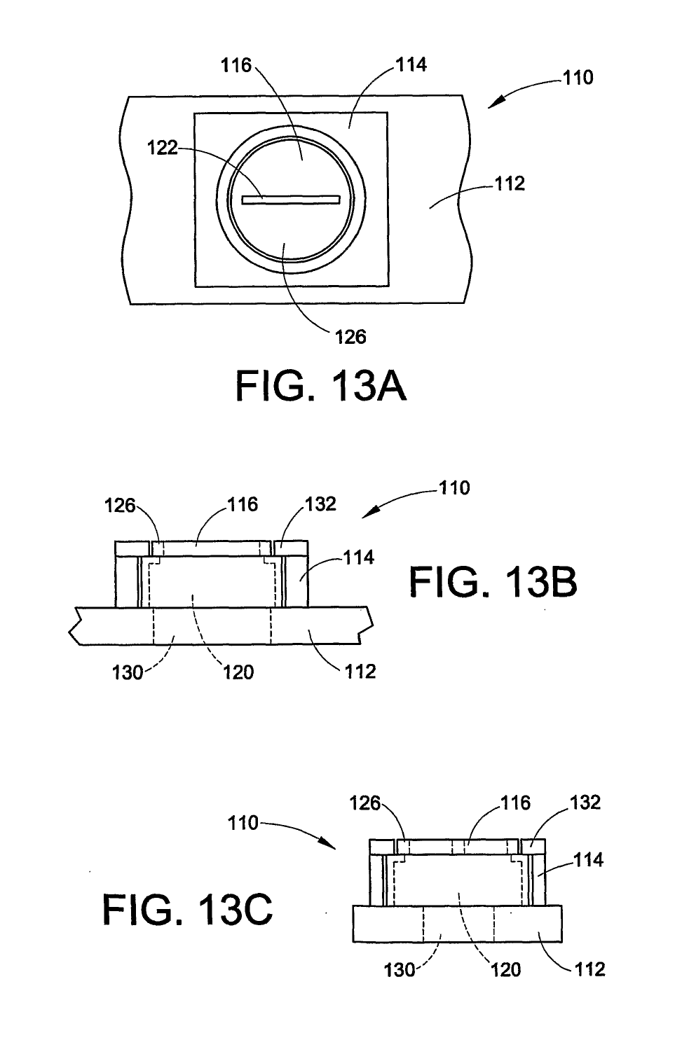

The inner swivel member 116 may be axially constrained in the outer swivel 114 member in a wide variety of different ways. In the example illustrated by FIGS. 13A-13C, the inner swivel member 116 is axially constrained in the outer swivel member 114 by a plate 132 that includes a central opening.

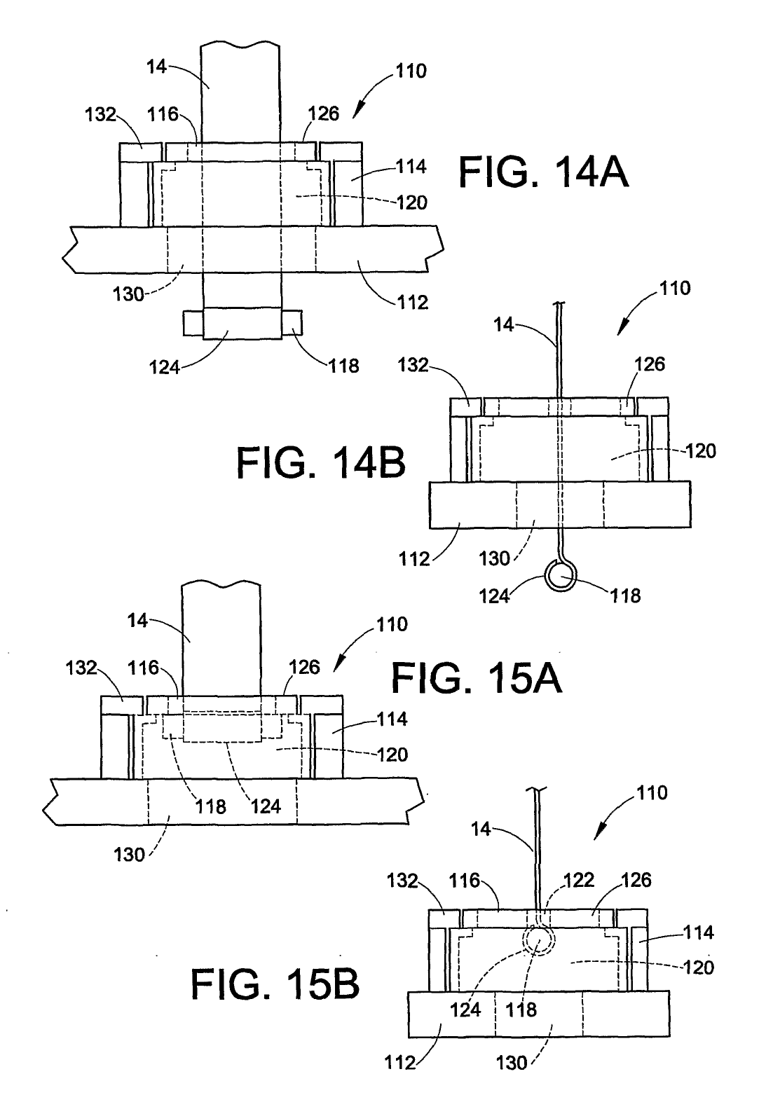

The line 14 can be secured to the stop member 118 in a wide variety of different ways. In the example illustrated by FIGS. 14A and 14B, the stop member 118 is disposed in a loop 124 of the line. The illustrated attached member 112 includes a slot 130 that facilitates insertion of the stop member 118 into the loop 124. The stop member 118 may take a wide variety of different forms. Any stop member 118 that prevents the loop 124 from being pulled through the inner swivel member may be used. For example, the stop member 118 may be a cylindrical pin.

FIGS. 14A, 14B, 15A and 15B illustrate use of the swivel assembly 110 to attach a line 14 to the member 112 to permit relative rotation between the line 14 and the member 112. The loop 124 of the line 14 may be inserted through the inner swivel member 116 and the member 112. The stop member 118 is inserted into the loop 124. The line 14 is pulled to pull the loop 124 and stop member 118 through the member 112 and into engagement with the inner swivel member 116. The inner swivel member 116 rotates inside the outer swivel member 116 to allow relative rotation between the line 14 and the attached member 112.

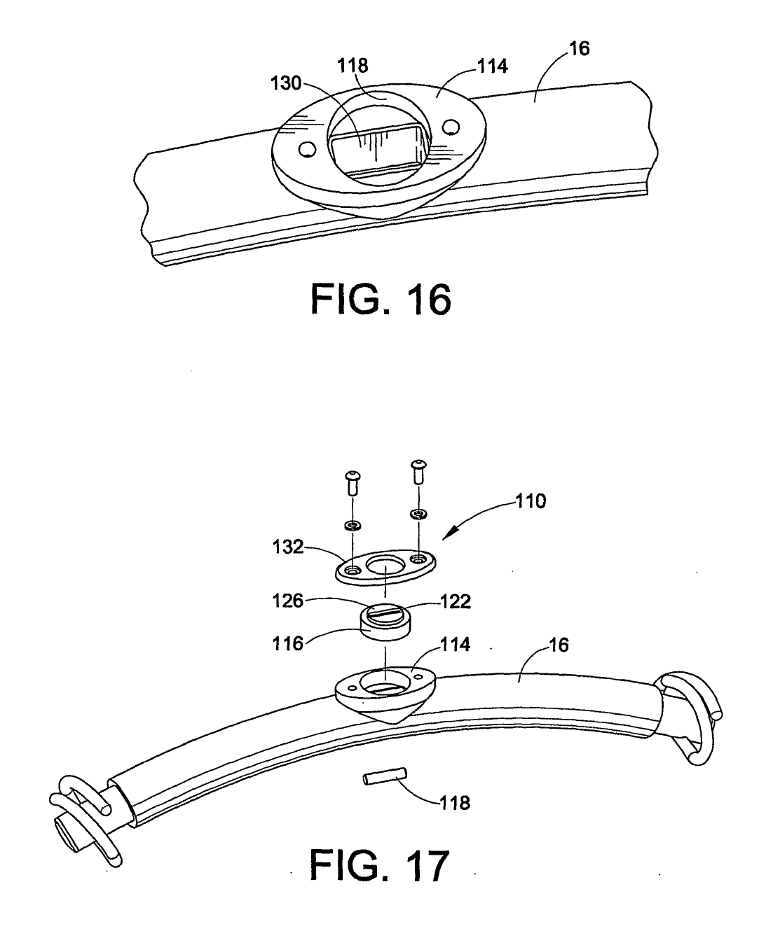

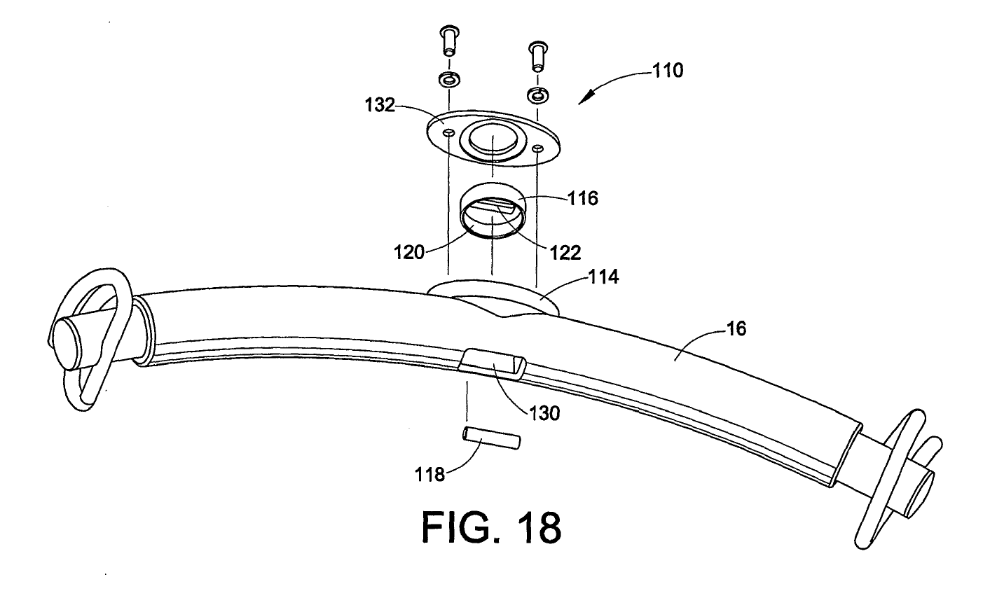

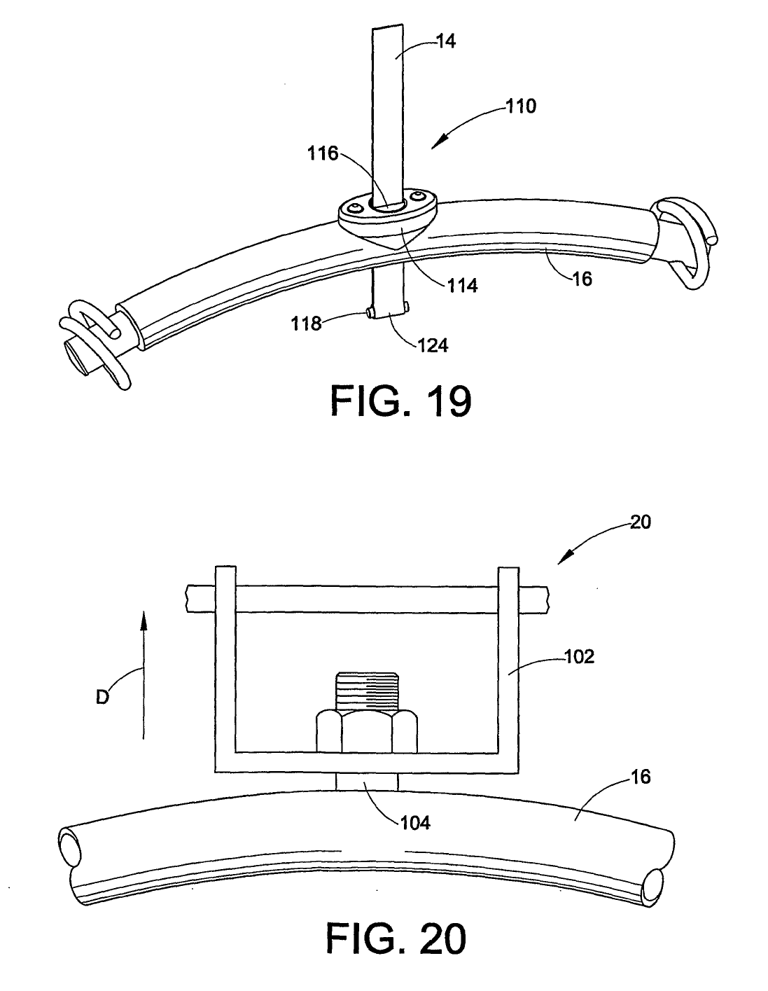

The swivel assembly 110 can be used in a wide variety of different applications, including applications where a low-profile swivel assembly is advantageous. The swivel assembly 110 has a much lower profile than the swivel assembly illustrated by FIG. 10 and FIG. 20. Referring to FIGS. 16-19, one application where a low profile swivel assembly 110 is beneficial is on the carry bar 16 of a ceiling lift. The low profile of the swivel assembly 110 allows the carry bar 16 to be moved closer to the lift unit 12 than the swivel assemblies 100 illustrated by FIGS. 10 and 20.

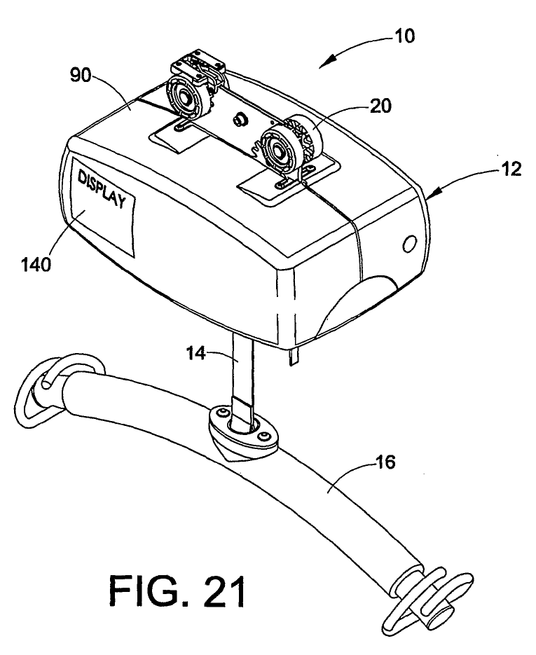

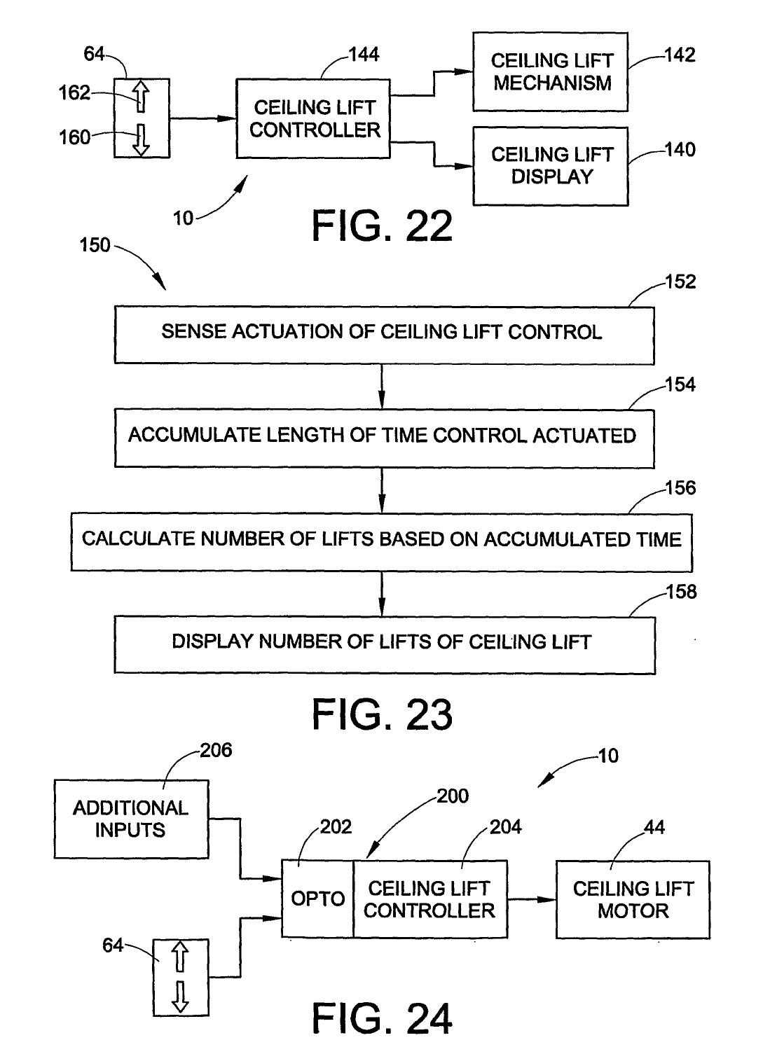

FIGS. 21 and 22 illustrate an embodiment of a ceiling lift 10 that includes a display 140. The display 140 can be mounted or positioned at any location that accessible or visible to the user and/or service personnel. Such locations include, but are not limited to, on a surface of the lift unit 12, such as a lower surface of the lift unit that faces downward toward the user. The ceiling lift includes a lift mechanism 142, a controller 144 in communication with the lifting mechanism, the user control 64 in communication with the controller, and the display 140. The lifting mechanism 142 may be any mechanism that lifts and lowers a patient, including, but not limited to the lift unit 12 disclosed above. The display 140 may display any parameter that relates to operation of the lift or the condition of the lift. Examples of information that can be displayed includes, but is not limited to, a number of lift cycles performed by the lift, a number of lift cycles remaining before service is due, an amount of time the lift has been operated, an amount of time the lift can be operated before service is due, battery information, and other information relating to functioning of the lift.

In one embodiment the lift unit includes the lift line 14 and the controller 144 is programmed to monitor the extending and retracting of the lift line. The display 140 is in communication with the controller 144 and displays information relating to extending and retracting of the lift line.

The number of lifts performed by the lift unit can be determined or approximated in a wide variety of different ways. FIG. 23 illustrates one method 150 for approximating a number of lifts performed by a ceiling lift. In the method, actuation of the ceiling lift control is sensed 152. An amount of time the ceiling lift control is actuated is tracked or accumulated 154. The number of lifts is calculated 156 based on the amount of time the control is actuated. The calculated number of lifts can then be displayed 158.

The number of lifts can be calculated based on the amount of time the lift is actuated in a wide variety of different ways. In one embodiment, a combined total of the time that the up or down buttons 160, 162 (FIG. 22) are pressed can be divided by a predetermined time value per lift cycle to calculate the number of lift cycles. For example, if it takes approximately thirty seconds to lift and lower a patient, a number of lift cycles may be calculated by dividing the amount of time the lift is being operated to raise or lower the lift line by thirty seconds. The amount of time that corresponds to one lift depends on the parameters of the lift. A wide variety of other algorithms could also be employed to calculate the number of lifts.

FIG. 24 illustrates an embodiment of a control board 200 for a ceiling lift that includes an optocoupler 202. The optocoupler 202 may be in communication with a controller 204 and a user control 64 of the lift for protecting the controller from electromagnetic noise. The optocoupler may also be in communication with additional inputs 206 to the controller. For example, the limit switches 90 illustrated in FIG. 9 may be coupled to the controller 204 through the optocoupler.

It should be understood that the embodiments discussed above are representative of aspects of the invention and are provided as examples and not an exhaustive description of implementations of an aspect of the invention.

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, software, hardware, control logic and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

1. A ceiling lift gear box assembly comprising:
a top plate;
a first side plate assembled with the top plate;
a second side plate assembled with the top plate and spaced apart from the first side plate;
a bottom plate assembled with the first side plate and the second plate and spaced apart from the top plate, wherein the top plate, the first side plate, the second side plate, and the bottom plate define an interior space;
a drive gear disposed in the interior space;
a driven gear disposed in the interior space, such that rotation of the drive gear causes rotation of the driven gear;
a line coupled to the driven gear such that rotation of the driven gear in a first direction extends the line from the interior space and rotation of the driven gear in a second direction retracts the line into the interior space.

2. The ceiling lift gear box assembly of claim 1 further comprising a flange extending from the top plate an a roller assembled with the flange that extends from the top plate.

3. The ceiling lift gear box assembly of claim 2 wherein the roller is configured to ride in a ceiling mounted track.

4. The ceiling lift gear box assembly of claim 1 wherein the top plate and the first side plate are connected by a tongue and groove connection.

5. The ceiling lift gear box assembly of claim 1 wherein the bottom plate and the first side plate are connected by a tongue and groove connection.

6. The ceiling lift gear box assembly of claim 1 wherein the top plate, the first side plate, the second side plate, and the bottom plate are assembled together with tongue and groove connections.

7. The ceiling lift gear box of claim 1 wherein the top plate, the first side plate, the second side plate, and the bottom plate are extruded.

8. The ceiling lift gear box of claim 1 wherein the top plate, the first side plate, the second side plate, and the bottom plate are extruded from aluminum.

9. The ceiling lift gear box of claim 1 wherein the top plate, the first side plate, the second side plate, and the bottom plate are assembled by slidably engaging the first side plate and the second side plate with the top plate and by slideably engaging the first side plate and the second side plate with the bottom plate.

10. A method of assembling a ceiling lift assembly comprising:
mounting components of the lift to a top plate to construct a top plate assembly;
mounting components of the lift to a first side plate to construct a first side plate assembly;
mounting components of the lift to a second side plate to construct a second side plate assembly;
mounting components lift to a bottom plate to construct a bottom plate assembly;
slidably engaging the first side plate and the second side plate with the top plate to assemble the first side plate assembly and the second side plate assembly with the top plate assembly;
slideably engaging the first side plate and the second side plate with the bottom plate to assemble the first side plate assembly and the second side plate assembly with the bottom plate assembly.

11. A swivel connection that permits relative rotation between a line and an attached member comprising:
an outer swivel member connected to the member that defines a recess;
an inner swivel member axially constrained in the recess of the outer swivel, the inner swivel member includes an end wall and a side wall that extends axially from the end wall to define a cavity, the inner swivel member includes a lift line opening that is defined through the end wall of the inner member.

12. The swivel connection of claim 11 further comprising a stop member disposed in the cavity.

13. The swivel connection of claim 11 wherein the line includes a loop that is disposed around the stop member.

14. The swivel connection of claim 11 wherein the stop member engages the end wall to prevent the loop from being pulled through the line opening.

15. The swivel connection of claim 11 wherein the inner swivel member is rotatable with respect to the outer swivel member to facilitate rotation of the member attached to the line.

16. A swivel connection for a ceiling lift that permits relative rotation between a lift line and a carry bar comprising:
an outer swivel member connected to the carry bar that defines a recess;
an inner swivel member axially constrained in the recess, the inner swivel member includes an end wall and a side wall that extends axially from the end wall to define a cavity, the inner swivel member includes a lift line opening that is defined through the end wall of the inner member;
a stop member disposed in the cavity;
wherein the lift line includes a loop that is disposed around the stop member;
wherein the stop member engages the end wall to prevent the loop from being pulled through the lift line opening;
wherein the inner swivel member is rotatable with respect to the outer swivel member and the carry bar to facilitate rotation of the carry bar with respect to the lift line.

17. The swivel connection of claim 16 wherein the carry bar includes a slot that facilitates insertion of the stop member into the loop.

18. The swivel connection of claim 16 wherein the slot in the lift bar allows the loop and the stop member to be pulled through the lift bar and into engagement with the inner swivel member by pulling the line.

19. The swivel connection of claim 16 wherein the axially extending wall of the inner swivel member is generally annular wherein the end wall of the inner swivel member is disk shaped.

20. The swivel connection of claim 16 wherein the inner swivel member is secured in the recess of the outer swivel member by a plate.

21. A ceiling lift comprising:
a lifting mechanism;
a controller in communication with the lifting mechanism;
a user control in communication with the controller;
a lift line that is selectively extended and retracted by the lifting mechanism unit upon operation of the user control, wherein the controller is programmed to monitor the extending and retracting of the lift line;
a display in communication with the controller for displaying information relating to extending and retracting of the lift line.

22. The ceiling lift of claim 21 wherein the display displays a number of lifts performed by the lifting mechanism.

23. The ceiling lift of claim 21 wherein the display displays an amount of time a motor of the lifting mechanism has run.

24. The ceiling lift of claim 21 wherein the display displays a number of lifts remaining until maintenance is required.

25. The ceiling lift of claim 21 wherein the display displays an amount of motor operation time remaining until maintenance is required.

26. The ceiling lift of claim 21 wherein the controller monitors operation of the user control to determine a number of lifts performed by the lifting mechanism.

27. The ceiling lift of claim 21 wherein the controller monitors operation of the lifting mechanism to determine a number of lifts performed by the lifting mechanism.

28. A method of determining a number of lifts performed by a ceiling lift comprising:
sensing actuation of a ceiling lift control;
tracking an amount of time the ceiling lift control is actuated;
calculating the number of lifts based on the amount of time the control is actuated;
displaying the number of lifts.

29. A ceiling lift comprising:
a lifting mechanism;
a controller in communication with the lifting mechanism;
a user control in communication with the controller;
an optocoupler in communication with the controller and the user control for protecting the controller from electromagnetic noise.
a lift line that is selectively extended and retracted by the lifting mechanism unit upon operation of the user control.

30. The ceiling lift of claim 29 wherein the optocoupler is in communication additional inputs to the controller.

31. The ceiling lift of claim 29 wherein the additional inputs comprise limit switches.
